(19) United States
(12) Patent Application Publication
(10) Pub. No.: US 2026/0004052 A1
(43) Pub. Date: Jan. 1, 2026

(54) IMAGE CONTEXT BASED TEXT GENERATION

(71) Applicant: Shutterstock, Inc., New York, NY (US)

(72) Inventors: Raymond Lúí Smyth, Dublin (IE); Christopher Loy, London (GB)

(21) Appl. No.: 18/754,378

(22) Filed: Jun. 26, 2024

(51) Int. Cl. G06F 40/166; G06F 16/532; G06F 40/106; G06V 20/70

(52) U.S. Cl. CPC G06F 40/166; G06F 16/532; G06F 40/106; G06V 20/70

(57) ABSTRACT

Methods, systems, and storage media for generating contextually relevant text from image descriptions and user intent are disclosed. Exemplary implementations may: receive an image and a user-defined intent for text output; analyze the received image to generate a contextual description of the image; generate a query based on the contextual description of the image and the user-defined intent; and generate the text output based on the query.

### TECHNICAL FIELD

The present disclosure generally relates to content generation, and more particularly to image context based artificial intelligence (AI) text generation, providing enhanced text outputs that better align with user objectives.

### BACKGROUND

The integration of text with visual media may be a common practice, particularly in marketing, social media, and online communication. Large Language Models (LLMs) may be employed to generate text based on user prompts, enhancing efficiency and creativity in content generation. These models may be trained on vast datasets to understand and produce human-like text. However, traditional text generation methods primarily rely on textual input and do not consider visual context, leading to a disconnect between the text and the accompanying images. This limitation may be evident in stock image services and applications where users often need to manually craft text that aligns with the visual content they select.

### BRIEF SUMMARY

The subject disclosure provides for systems and methods for content generation. A user is allowed to generate text that is contextually aligned with an image, enhancing the relevance and appeal of the content. For example, the generated text may reflect the mood, theme, or activity depicted in the image to create a cohesive narrative or message.

One aspect of the present disclosure relates to a method for generating contextually relevant text from image descriptions and user intent. The method may include receiving an image and a user-defined intent for text output. The method may include analyzing the received image to generate a contextual description of the image. The method may include generating a query based on the contextual description of the image and the user-defined intent. The method may include generating the text output based on the query.

Another aspect of the present disclosure relates to a system configured for generating contextually relevant text from image descriptions and user intent. The system may include one or more hardware processors configured by machine-readable instructions. The processor(s) may be configured to receive an image and a user-defined intent for text output. The processor(s) may be configured to analyze the received image to generate a contextual description of the image. The processor(s) may be configured to generate a query based on the contextual description of the image and the user-defined intent. The processor(s) may be configured to generate the text output based on the query.

Yet another aspect of the present disclosure relates to a non-transient computer-readable storage medium having instructions embodied thereon, the instructions being executable by one or more processors to perform a method for generating contextually relevant text from image descriptions and user intent. The method may include receiving an image and a user-defined intent for text output. The method may include analyzing the received image to generate a contextual description of the image. The method may include generating a query based on the contextual description of the image and the user-defined intent. The method may include generating the text output based on the query.

Still another aspect of the present disclosure relates to a system configured for generating contextually relevant text from image descriptions and user intent. The system may include means for receiving an image and a user-defined intent for text output. The system may include means for analyzing the received image to generate a contextual description of the image. The system may include means for generating a query based on the contextual description of the image and the user-defined intent. The system may include means for generating the text output based on the query.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a block diagram illustrating an overview of an environment in which some implementations of the disclosed technology can operate.

FIG. 2 illustrates an example sequence diagram for generating contextually relevant text from image descriptions and user intent, according to certain aspects of the disclosure.

FIG. 3 illustrates a block diagram of a process of the AI text generator for generating a text output, in accordance with one or more implementations.

FIGS. 4A, 4B, 4C, and 4D illustrate example views of an application configured for generating contextually relevant text from image descriptions and user intent, in accordance with one or more implementations.

FIG. 5 illustrates a system configured for content generation, in accordance with one or more implementations.

FIG. 6 illustrates an example flow diagram for content generation, according to certain aspects of the disclosure.

FIG. 7 is a block diagram illustrating an example computer system (e.g., representing both client and server) with which aspects of the subject technology can be implemented.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

In the following detailed description, numerous specific details are set forth to provide a full understanding of the present disclosure. It will be apparent, however, to one ordinarily skilled in the art, that the embodiments of the present disclosure may be practiced without some of these specific details. In other instances, well-known structures and techniques have not been shown in detail so as not to obscure the disclosure.

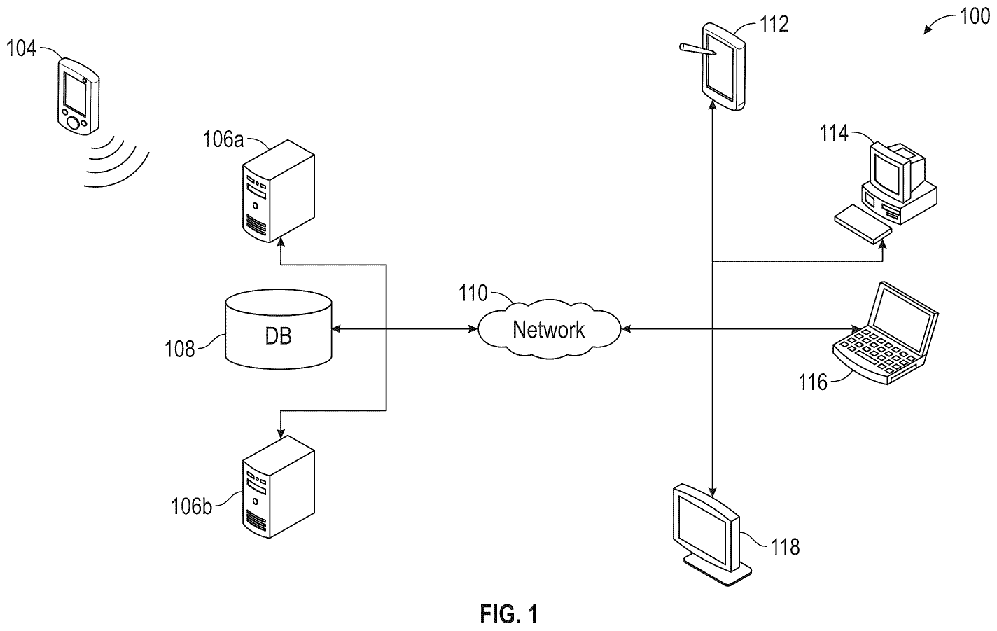

FIG. 1 is a block diagram illustrating an overview of an environment 100 in which some implementations of the disclosed technology can operate. The environment 100 can include one or more client computing devices, mobile device 104, tablet 112, personal computer 114, laptop 116, desktop 118, and/or the like. Client devices may communicate wirelessly via the network 110. The client computing devices can operate in a networked environment using logical connections through network 110 to one or more remote computers, such as server computing devices.

In some implementations, the environment 100 may include a server such as an edge server which receives client requests and coordinates fulfillment of those requests through other servers. The server may include the server computing devices 106a-106b, which may logically form a single server. Alternatively, the server computing devices 106a-106b may each be a distributed computing environment encompassing multiple computing devices located at the same or at geographically disparate physical locations. The client computing devices and server computing devices 106a-106b can each act as a server or client to other server/client device(s). The server computing devices 106a-106b can connect to a database 108 or can comprise its own memory. Each server computing devices 106a-106b can correspond to a group of servers, and each of these servers can share a database 108 or can have their own database 108. The database 108 may logically form a single unit or may be part of a distributed computing environment encompassing multiple computing devices that are located within their corresponding server, located at the same, or located at geographically disparate physical locations.

The network 110 can be a local area network (LAN), a wide area network (WAN), a mesh network, a hybrid network, or other wired or wireless networks. The network 110 may be the Internet or some other public or private network. Client computing devices can be connected to network 110 through a network interface, such as by wired or wireless communication. The connections can be any kind of local, wide area, wired, or wireless network, including the network 110 or a separate public or private network.

In some content generation systems, users may frequently encounter the challenge of creating text that complements and enhances the visual message conveyed by images. This process may be time-consuming and requires a level of creativity and contextual understanding that may not be innate to all users. Existing text generation tools that utilize LLMs may not account for the visual elements of an image, resulting in generic or mismatched text that fails to capture the unique context and intended use of the image. This gap in the technology may hinder the creation of cohesive and engaging content, particularly for users who lack the skills or time to manually tailor text to match visual content.

The subject disclosure provides for systems and methods for content generation. A user is allowed to generate text that is contextually aligned with an image, enhancing the relevance and appeal of the content. For example, the generated text may reflect the mood, theme, or activity depicted in the image to create a cohesive narrative or message.

Implementations described herein address the aforementioned shortcomings and other shortcomings by providing a feature that leveraging a LLM to analyze both the visual context provided by an image and the user's intent for the text output. The feature may be integrated into a text generation interface. The system may allow users to upload an image and specify their desired use case, such as a social media post or marketing material. The LLM may then generate text that is contextually relevant to the image and aligns with the user's specified content type and tone.

In practice, the feature may be activated by the user, prompting the LLM to consider the image's visual elements and any associated descriptions. The model may use this information, along with the user's input regarding the text's purpose, to craft text that is both appropriate and engaging for the intended audience. This solution not only streamlines the content creation process but also enhances the relevance and appeal of the final output, providing users with a powerful tool to create harmonized text and image content efficiently.

In some implementations, a feature within a text generation interface may leverage a LLM to produce text that corresponds with both an image's visual context and a user's specified intent for the text output. This feature, referred to as the image influence feature, may allow for the extraction of contextual information from an image which can then be used to tailor the generated text to fit a particular use case. The system may include physical components such as a user's computing device, an application server hosting the text generation interface, and a network infrastructure that facilitates communication between the user's device and the server.

The text generation interface may be part of an application that includes text generation, image generation, and/or image search capabilities. By non-limiting example, a user may download an image via the application. The download may trigger a prompt to appear, inviting the user to generate text for the image. The interface may provide options for the user to activate the image influence feature, which may then accept one or more images for consideration. The interface may also allow the user to input a description of their intent for the text output, which may include details such as the type of event, product, or service being promoted, as well as any relevant contextual information like date, time, location, or theme.

The system may also include filtering options within the text generation interface, allowing the user to further customize results according to their desired use case. These options may include content type selection, structuring the text for a specific type of content such as an email or social media post, and tone selection (e.g., bold, friendly, etc.), which may dictate the style of the generated text. The interface may display a sample layout of the potential output based on the selected content type, enabling the user to confirm that the output matches their objectives before finalizing their request to the LLM.

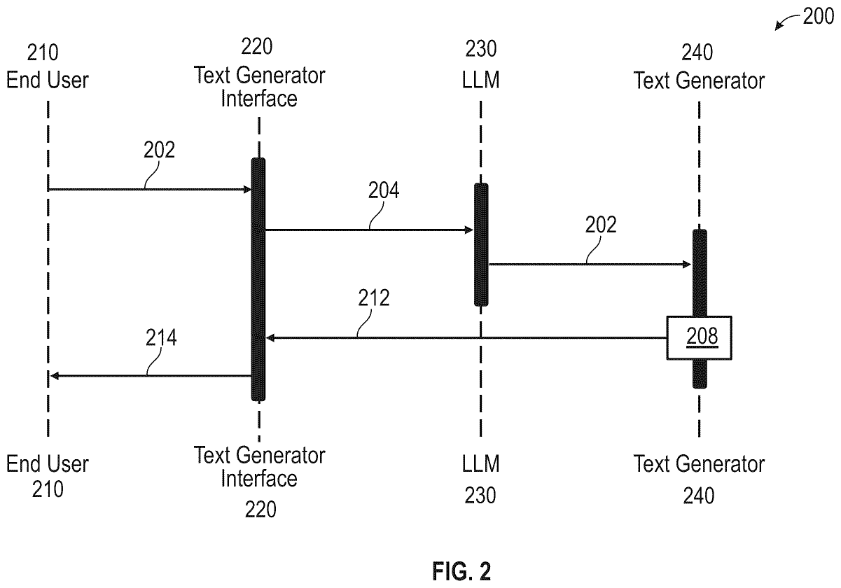

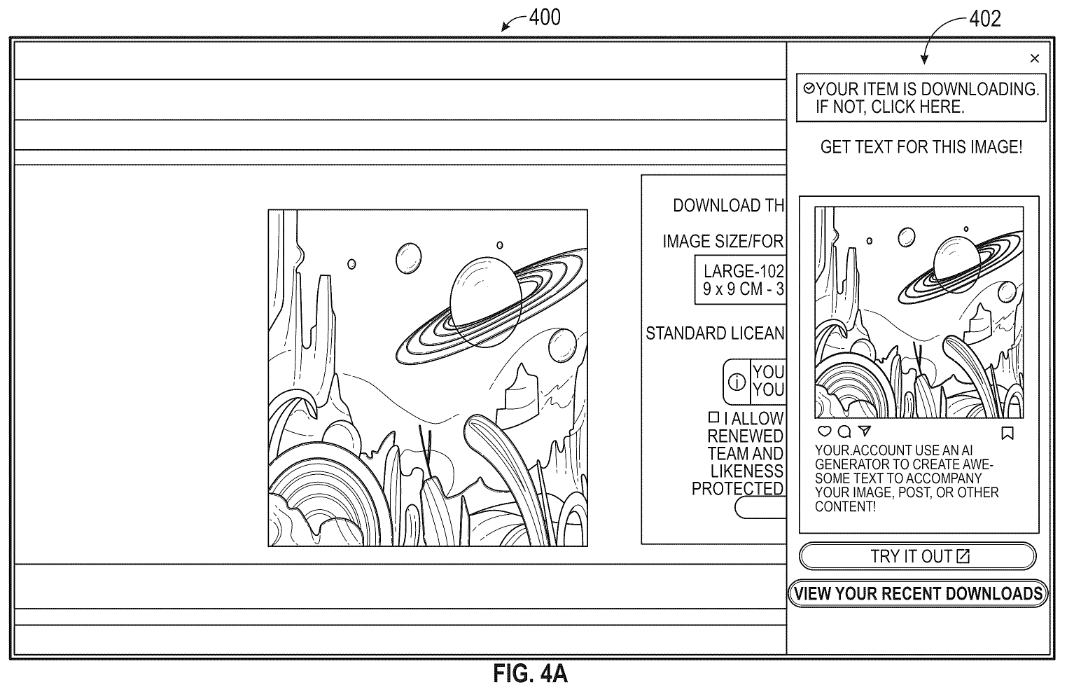

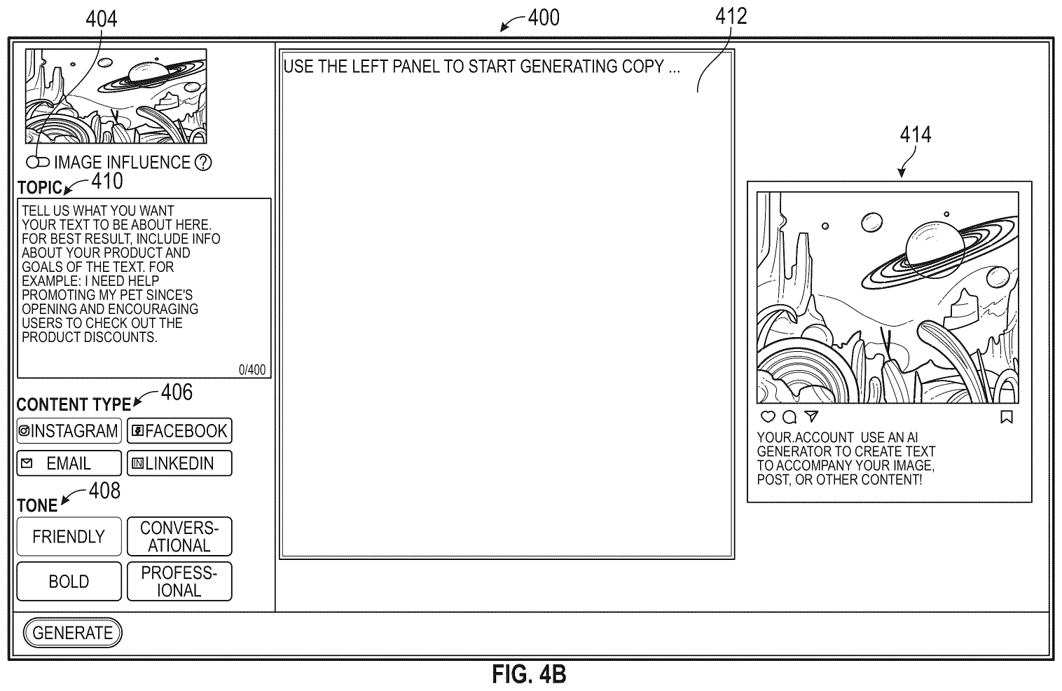

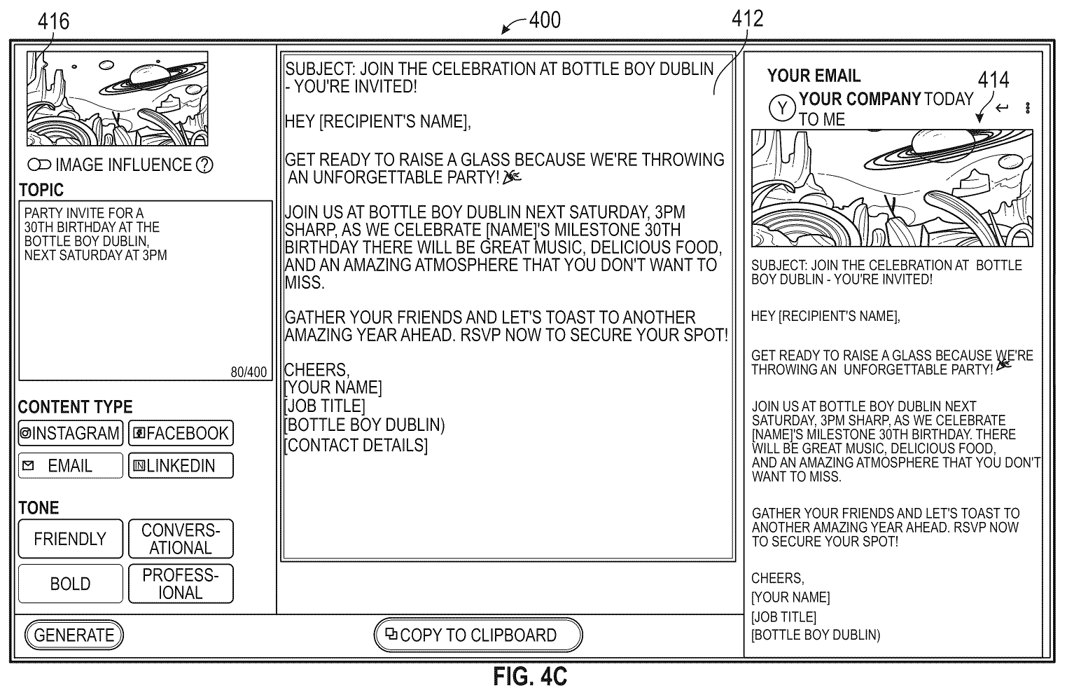

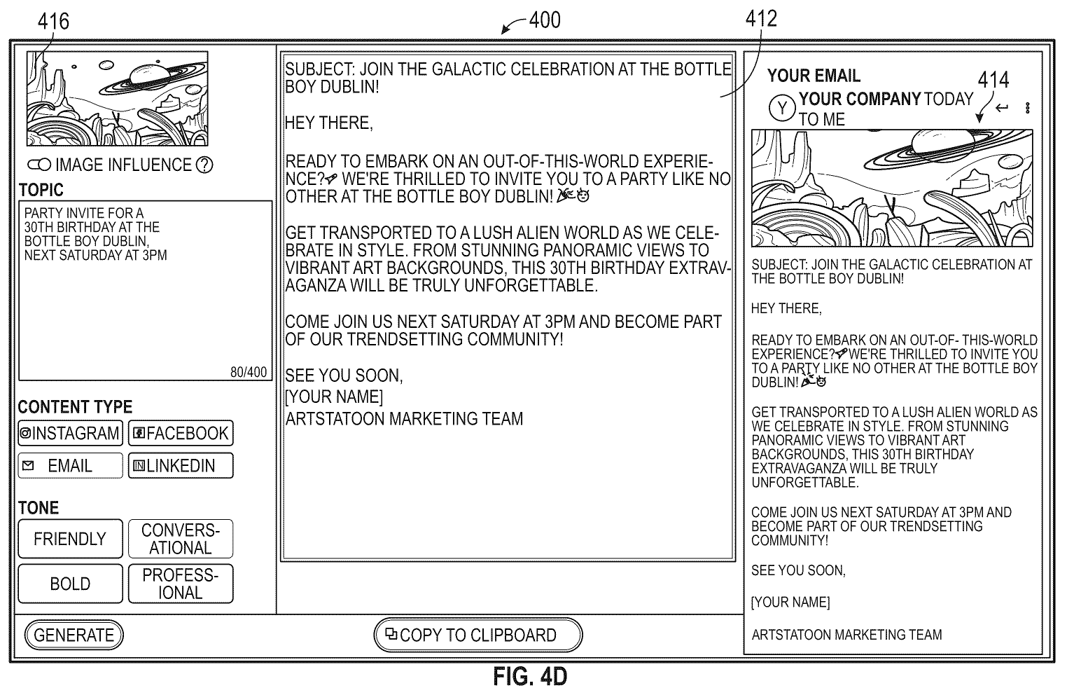

FIG. 2 illustrates an example sequence diagram 200 for generating contextually relevant text from image descriptions and user intent, according to certain aspects of the disclosure. The end user may commence this process from an initial application page (see, e.g., as depicted in FIG. 4A), and subsequently be directed to a text generator interface (see, e.g., as depicted in FIG. 4B).

At step 202, an end user 210 initiates a request by inputting details that describe their desired text output into a text generator interface 220. The end user 210 may specify various parameters such as content type, tone, and a detailed topic description. The topic description may provide LLM 230 with context to generate the appropriate text output (e.g., detailed for an event, an email, etc.). The topic description may describe the intent for text output. By non-limiting example, the intent may include a party invitation, conference, marketing intent, or the like. The description may detail contextual information about the intent (e.g., date, time, location, theme, etc.).

According to embodiments, the end user 210 may activate an image influence feature which enables the end user 210 to further input one or more images to influence the text output. When the image influence feature is active, the end user 210 may input an image (e.g., as another parameter) for consideration in the text generation. An image description may be determined from the image and prepended to the request.

At step 204, the text generator interface 220 may transmit multiple text arguments based on the request, including the end user's inputted details, to the LLM 230. This interface may be in communication with an application server that processes the LLM's operations. By non-limiting example, the text arguments may include a system message including context for the kind of text the end user desires, providing a specific starting prompt for the request. The context may be extracted from the end user's request. The system message provides instructions to the LLM 230, dictating aspects of generated text including, but not limited to, content type and tone. In some implementations, the system message may include instructions generated for the LLM 230 (e.g., “You are a marketing email writer, responsible for crafting marketing emails.”).

In some embodiments, the system message may be modified based on whether or not the image influence feature is selected by the end user 210. When the image influence feature is active, the system message may indicate to the LLM 230 to use both the image description as well as the topic description to generate the text output (e.g., a marketing email or the like). As such, the system message is prepared to reflect the fact that LLM 230 will receive a request that includes an image description as part of the end user 210 specified parameters.

At step 206, LLM 230 formulates a user query based on the inputs received at step 202 and forwards this query to an AI text generator 240. By non-limiting example, the inputs are analyzed to determine a product or service being promoted based on the content provided (e.g., a marketing email for an event or an invitation to a party). In some implementations, LLM 230 is included in the text generator 240. The text generator 240 may include one or more LLMs for generating natural language text output to the user.

According to some embodiments, the LLM 230 may filter the user query based on safety and privacy guidelines and/or filters. The LLM 230 may analyze the topic description and/or image description to identify themes from a predetermined list, filtering for potentially offensive terms, privacy, and/or other safety concerns. The LLM 230 may generate a notification if the end user 210 is trying to generate any of the themes on the predetermined list. By non-limiting example, the LLM 230 may generate a response output to the text generator interface 220 such as “Potentially Offensive Terms Detected.” By non-limiting example, if the user query fails a safety or privacy filter, an error message may be returned to the text generator interface 220. The error message may ask the end user 210 to rephrase their request (e.g., the topic description) and proceed to generating the text output only if the topic description is safe.

The AI text generator 240 may include one or more machine learning models stored in a database(s) (e.g., database 108). The AI text generator 240 may include algorithms trained for the specific purposes of an engine corresponding to the application. The algorithms may include machine learning or artificial intelligence algorithms making use of any linear or non-linear algorithm, such as a neural network algorithm, or multivariate regression algorithm. In some embodiments, the machine learning model may include an LLM, Natural Language Understanding (NLU) model, a neural network (NN), a convolutional neural network (CNN), a generative adversarial neural network (GAN), an unsupervised learning algorithm, a deep recurrent neural network (DRNN), a classic machine learning algorithm such as random forest, or any combination thereof. More generally, the machine learning model may include any machine learning model involving a training step and an optimization step. In some embodiments, the database 108 may include a training archive to modify coefficients according to a desired outcome of the machine learning model. Accordingly, in some embodiments, the application engine is configured to access database 108 to retrieve data and archives as inputs for the machine learning model.

At step 208, the text generator 240 produces text output, based on the user query, using a generative/AI model. The text output aligns with the end user 210 requested tone, content type, and image influences, which may encompass the context of the image or a textual description thereof, in addition to the topic description. For example, based on the identified product or service, the text generator 240 may generate a text output (e.g., a marketing email) in the specified tone, format (based on content type), and image influences (if applicable). In some embodiments, a length of the text output may be limited to a preset number of characters, words, or the like.

At step 212, the text generator 240 conveys the generated text output back to the text generator interface 220. At step 214, the text output is displayed to the end user 210 through the text generator interface 220 (see, e.g., as depicted in FIG. 4D).

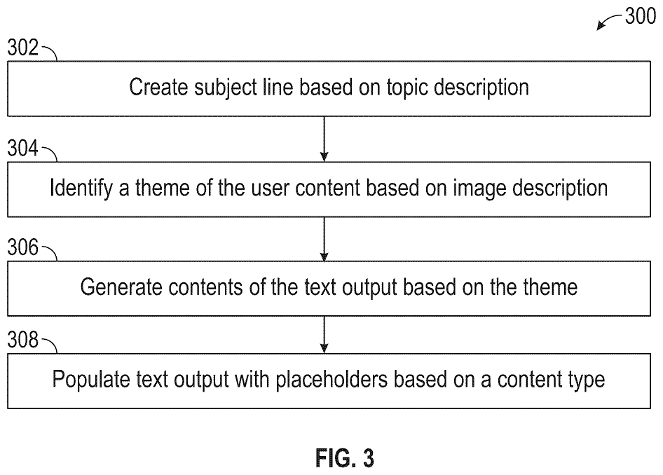

FIG. 3 illustrates a block diagram of a process 300 of the AI text generator for generating a text output based on an analysis of the user content (e.g., topic and image description). For example, the process 300 describes generating a marketing email as the text output. That is, the process 300 describes a set of guidelines may be for the email content type. However, this is merely for exemplary purposes and may include other embodiments which a person of ordinary skill in the art would reasonably understand to be text output generated by the AI text generator. Other templates including a set of guidelines corresponding to each content type may be implemented and stored at an application server or the like.

At step 302, an attention-grabbing subject line is created to entices recipients to open the email based on the topic description. The subject line may be concise and relevant to the user content.

At steps 304, a theme of the user content is identified based on the image description. In some implementations, the image is tagged and embedded with textual descriptions that are used as the image description. In some implementations, the user provides the image description.

At step 306, contents of the text output (e.g., an introduction and body) that addresses the user's main points or interests is generated based on the topic description, image description, and the theme. To clearly communicate the user intent, the body of the email may use short paragraphs and bullet points to improve clarity. Additionally, the text generator may avoid jargon or overly complex language. For example, depending on the selected tone, the text generator may use emojis where relevant to enhance the text output.

In some implementations, the text generator may highlight how the product or service benefits the recipient and generate the output text such that the contents focus on how the product or service is solving a problem or fulfilling a need.

At step 308, the text output is populated with placeholders based on a template correspond to the content type. For example, for an email content type, the text output may include a professional email signature with a name, job title, company, and contact details. The user may manually fill in this information at the placeholders upon receiving the output. In some embodiments, the user provides relevant information in the topic description such that the text generator may automatically input customizable details such as name, job title, company, contact details, etc. (rather than providing placeholders).

FIGS. 4A, 4B, 4C, and 4D illustrate example views 400 of an application configured for generating contextually relevant text from image descriptions and user intent, in accordance with one or more implementations. In FIG. 4A, the application presents an initial application page which may be presented to the user. For example, the initial page may be presented to the user when an image is downloaded. A pop-up 402 may be included prompting the user to generate text for the downloaded image. The user may also select to generate text for a previously downloaded image, new image, uploaded image, etc.

In FIG. 4B, the application presents a text generator interface may include one or more parameters for the user to select and/or input. For example, the user may toggle an image influence feature 404 to include image influences into a text output. The user may select a content type 406 and tone 408 for the text output. The content type 406 may include where the desired text will be used. The tone 408 may reflect a preferred tone for the desired text. The user may input a topic description 410 of their desired content wherein the user described an overall intent of the desired text. The text output may be generated (based on the parameters) and presented to the user in the text window 412. The text generator interface may include a sample 414 of a completed output based on the content type. For example, the user may select “Instagram” as the content type and the sample 414 may reflect an Instagram post including the generated text output.

In FIG. 4C, illustrates an example text output without the image influence feature toggle selected. In FIG. 4D, illustrates an example text output with the image influence feature toggle selected. As shown in the FIGS. 4C-4D, the text output is distinctly influenced by the contents and style of the image 416. In FIG. 4D, the “galactic” theme of the image 416 is exuding through in the text (e.g., with the use of emoticons and contextually relevant verbiage). As such, embodiments enhance the user experience and provide better, more creative, and unique text outputs that align with the user's intent and objectives.

As shown FIGS. 4C-4D, output text corresponding to an email content type may include placeholders for one or more standard email parameters (e.g., name, contact information). In some implementations, the user may include the values for the one or more standard email parameters in the input topic description 410. In this case, the email text output may be populated with the information automatically. According to embodiments, a copy of the text output may be saved or copied (e.g., copied to clipboard) by the user.

The disclosed system(s) address a problem in traditional content generation techniques tied to computer technology, namely, the technical problem of integrating visual content context to enhance the relevance and specificity of generated text. The disclosed system solves this technical problem by providing a solution also rooted in computer technology, namely, by providing for image context based text generation. The disclosed subject technology further provides improvements to the functioning of the computer itself because it improves processing and efficiency in content generation.

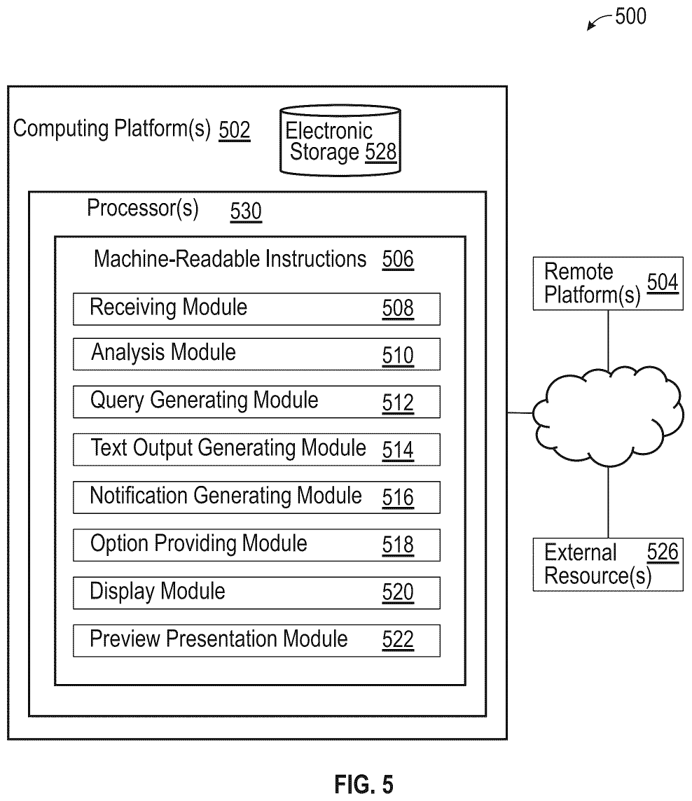

FIG. 5 illustrates a system 500 configured for content generation, according to certain aspects of the disclosure. In some implementations, system 500 may include one or more computing platforms 502. Computing platform(s) 502 may be configured to communicate with one or more remote platforms 504 according to a client/server architecture, a peer-to-peer architecture, and/or other architectures. Remote platform(s) 504 may be configured to communicate with other remote platforms via computing platform(s) 502 and/or according to a client/server architecture, a peer-to-peer architecture, and/or other architectures. Users may access system 500 via remote platform(s) 504.

Computing platform(s) 502 may be configured by machine-readable instructions 506. Machine-readable instructions 506 may include one or more instruction modules. The instruction modules may include computer program modules. The instruction modules may include one or more of receiving module 508, analysis module 510, query generating module 512, text output generating module 514, notification generating module 516, option providing module 518, display module 520, preview presentation module 522, and/or other instruction modules.

Receiving module 508 may be configured to receive an image and a user-defined intent for text output. The user defined intent may include content type and tone selections, a topic description, and/or influence feature selection. Each platform corresponding to content types may receive a customized version of the text output.

Analysis module 510 may be configured to analyze the received content. For example, the analysis module 510 may analyze the user-defined intent and the image to generate a contextual description of the image. By way of non-limiting example, the analyzing of the received image may include extracting visual elements such as colors, objects, and activities to enhance the contextual description. The tone selection may be dynamically adjusted in response to real-time sentiment analysis of the user-defined intent and the contextual description of the image.

Query generating module 512 may be configured to generate a query based on the contextual description of the image and the user-defined intent.

Text output generating module 514 may be configured to generate the text output based on the query. The text output generating module 514 may be configured to embed the generated text output with metadata that includes the contextual description of the image and the user-defined intent to facilitate indexing and retrieval of the text output. The generated text output may be configured for dissemination across multiple social media platforms. The generated text output may be tailored to match the specific event theme and audience.

Notification generating module 516 may be configured to generate a notification on a user device. The notification may be generated to invite the user to input the user-defined intent for text output immediately after the user downloads the image. The notification may be generated to inform the user of a safety or privacy concern with the input content (e.g., the image description and the user-defined intent).

Option providing module 518 may be configured to provide a toggle option within a text generator interface that allows the user to activate or deactivate consideration of the contextual description of the image in the text output generation.

Display module 520 may be configured to display the generated text output to the a user interface (e.g., the text generator interface).

Preview presentation module 522 may be configured to present a preview of the text output in a layout corresponding to the selected content type on the text generator interface for user confirmation before finalizing the text output. In some implementations, the content type selection may include options for various event invitations.

In some implementations, computing platform(s) 502, remote platform(s) 504, and/or external resources 526 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which computing platform(s) 502, remote platform(s) 504, and/or external resources 526 may be operatively linked via some other communication media.

A given remote platform 504 may include one or more processors configured to execute computer program modules. The computer program modules may be configured to enable an expert or user associated with the given remote platform 504 to interface with system 500 and/or external resources 526, and/or provide other functionality attributed herein to remote platform(s) 504. By way of non-limiting example, a given remote platform 504 and/or a given computing platform 502 may include one or more of a server, a desktop computer, a laptop computer, a handheld computer, a tablet computing platform, a NetBook, a Smartphone, a gaming console, and/or other computing platforms.

External resources 526 may include sources of information outside of system 500, external entities participating with system 500, and/or other resources. In some implementations, some or all of the functionality attributed herein to external resources 526 may be provided by resources included in system 500.

Computing platform(s) 502 may include electronic storage 528, one or more processors 530, and/or other components. Computing platform(s) 502 may include communication lines, or ports to enable the exchange of information with a network and/or other computing platforms. Illustration of computing platform(s) 502 in FIG. 5 is not intended to be limiting. Computing platform(s) 502 may include a plurality of hardware, software, and/or firmware components operating together to provide the functionality attributed herein to computing platform(s) 502. For example, computing platform(s) 502 may be implemented by a cloud of computing platforms operating together as computing platform(s) 502.

Electronic storage 528 may comprise non-transitory storage media that electronically stores information. The electronic storage media of electronic storage 528 may include one or both of system storage that is provided integrally (i.e., substantially non-removable) with computing platform(s) 502 and/or removable storage that is removably connectable to computing platform(s) 502 via, for example, a port (e.g., a USB port, a firewire port, etc.) or a drive (e.g., a disk drive, etc.). Electronic storage 528 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 528 may include one or more virtual storage resources (e.g., cloud storage, a virtual private network, and/or other virtual storage resources). Electronic storage 528 may store software algorithms, information determined by processor(s) 530, information received from computing platform(s) 502, information received from remote platform(s) 504, and/or other information that enables computing platform(s) 502 to function as described herein.

Processor(s) 530 may be configured to provide information processing capabilities in computing platform(s) 502. As such, processor(s) 530 may include one or more of a digital processor, an analog processor, a digital circuit designed to process information, an analog circuit designed to process information, a state machine, and/or other mechanisms for electronically processing information. Although processor(s) 530 is shown in FIG. 5 as a single entity, this is for illustrative purposes only. In some implementations, processor(s) 530 may include a plurality of processing units. These processing units may be physically located within the same device, or processor(s) 530 may represent processing functionality of a plurality of devices operating in coordination. Processor(s) 530 may be configured to execute modules 508, 510, 512, 514, 516, 518, and/or 520, 522 and/or other modules. Processor(s) 530 may be configured to execute modules 508, 510, 512, 514, 516, 518, 520, and/or 522 and/or other modules by software; hardware; firmware; some combination of software, hardware, and/or firmware; and/or other mechanisms for configuring processing capabilities on processor(s) 530. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 508, 510, 512, 514, 516, 518, 520, and/or 522 are illustrated in FIG. 5 as being implemented within a single processing unit, in implementations in which processor(s) 530 includes multiple processing units, one or more of modules 508, 510, 512, 514, 516, 518, 520, and/or 522 may be implemented remotely from the other modules. The description of the functionality provided by the different modules 508, 510, 512, 514, 516, 518, 520, and/or 522 described below is for illustrative purposes, and is not intended to be limiting, as any of modules 508, 510, 512, 514, 516, 518, 520, and/or 522 may provide more or less functionality than is described. For example, one or more of modules 508, 510, 512, 514, 516, 518, 520, and/or 522 may be eliminated, and some or all of its functionality may be provided by other ones of modules 508, 510, 512, 514, 516, 518, 520, and/or 522. As another example, processor(s) 530 may be configured to execute one or more additional modules that may perform some or all of the functionality attributed below to one of modules 508, 510, 512, 514, 516, 518, 520, and/or 522.

The techniques described herein may be implemented as method(s) that are performed by physical computing device(s); as one or more non-transitory computer-readable storage media storing instructions which, when executed by computing device(s), cause performance of the method(s); or, as physical computing device(s) that are specially configured with a combination of hardware and software that causes performance of the method(s).

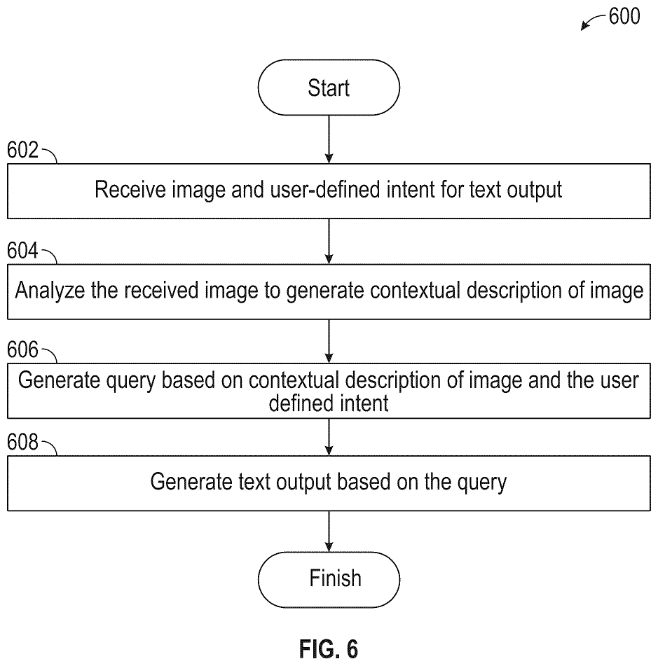

FIG. 6 illustrates an example flow diagram (e.g., process 600) for content generation, according to certain aspects of the disclosure. For explanatory purposes, the example process 600 is described herein with reference to FIGS. 1-5. Further for explanatory purposes, the steps of the example process 600 are described herein as occurring in serial, or linearly. However, multiple instances of the example process 600 may occur in parallel. For purposes of explanation of the subject technology, the process 600 will be discussed in reference to FIGS. 1-5.

At step 602, the process 600 may include receiving an image and a user-defined intent for text output. At step 604, the process 600 may include analyzing the received image to generate a contextual description of the image. At step 606, the process 600 may include generating a query based on the contextual description of the image and the user-defined intent. At step 608, the process 600 may include generating the text output based on the query.

For example, as described above in relation to FIG. 6, at step 602, the process 600 may include receiving an image and a user-defined intent for text output, through receiving module 508. At step 604, the process 600 may include analyzing the received image to generate a contextual description of the image, through analysis module 510. At step 606, the process 600 may include generating a query based on the contextual description of the image and the user-defined intent, through query generating module 512. At step 608, the process 600 may include generating the text output based on the query, through text output generating module 514.

According to an aspect, the process 600 may include generating a notification on a user device inviting the user to input the user-defined intent for text output immediately after the user downloads the image.

According to an aspect, the process 600 may include providing a toggle option within a text generator interface that allows the user to activate or deactivate consideration of the contextual description of the image in the text output generation.

According to an aspect, the process 600 may include embedding the generated text output with metadata that includes the contextual description of the image and the user-defined intent to facilitate indexing and retrieval of the text output.

According to an aspect, the process 600 may include presenting a preview of the text output in a layout corresponding to the selected content type on the text generator interface for user confirmation before finalizing the text output.

According to an aspect, the process 600 may include filtering the user-defined intent through a safety and privacy guideline checker to detect and respond to potentially offensive terms before generating the text output.

According to an aspect, the analyzing of the received image includes extracting visual elements such as colors, objects, and activities to enhance the contextual description.

According to an aspect, the generated text output is configured for dissemination across multiple social media platforms, each platform receiving a customized version of the text output.

According to an aspect, the content type selection includes options for various event invitations, and the generated text output is tailored to match the specific event theme and audience.

According to an aspect, the tone selection is dynamically adjusted in response to real-time sentiment analysis of the user-defined intent and the contextual description of the image.

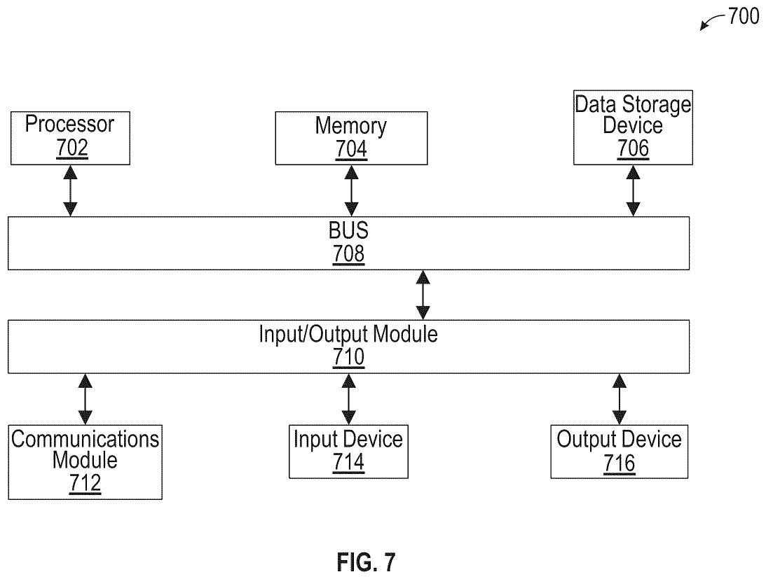

FIG. 7 is a block diagram illustrating an exemplary computer system 700 with which aspects of the subject technology can be implemented. In certain aspects, the computer system 700 may be implemented using hardware or a combination of software and hardware, either in a dedicated server, integrated into another entity, or distributed across multiple entities.

Computer system 700 (e.g., server and/or client) includes a bus 708 or other communication mechanism for communicating information, and a processor 702 coupled with bus 708 for processing information. By way of example, the computer system 700 may be implemented with one or more processors 702. Processor 702 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 700 can include, in addition to hardware, code that creates an execution environment for the computer program in question, e.g., code that constitutes processor firmware, a protocol stack, a database management system, an operating system, or a combination of one or more of them stored in an included memory 704, such as a Random Access Memory (RAM), a flash memory, a Read-Only Memory (ROM), a Programmable Read-Only Memory (PROM), an Erasable PROM (EPROM), registers, a hard disk, a removable disk, a CD-ROM, a DVD, or any other suitable storage device, coupled to bus 708 for storing information and instructions to be executed by processor 702. The processor 702 and the memory 704 can be supplemented by, or incorporated in, special purpose logic circuitry.

The instructions may be stored in the memory 704 and implemented in one or more computer program products, i.e., one or more modules of computer program instructions encoded on a computer-readable medium for execution by, or to control the operation of, the computer system 700, and according to any method well-known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 704 may also be used for storing temporary variable or other intermediate information during execution of instructions to be executed by processor 702.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 700 further includes a data storage device 706 such as a magnetic disk or optical disk, coupled to bus 708 for storing information and instructions. Computer system 700 may be coupled via input/output module 710 to various devices. The input/output module 710 can be any input/output module. Exemplary input/output modules 710 include data ports such as USB ports. The input/output module 710 is configured to connect to a communications module 712. Exemplary communications modules 712 include networking interface cards, such as Ethernet cards and modems. In certain aspects, the input/output module 710 is configured to connect to a plurality of devices, such as an input device 714 and/or an output device 716. Exemplary input devices 714 include a keyboard and a pointing device, e.g., a mouse or a trackball, by which a user can provide input to the computer system 700. Other kinds of input devices 714 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback, and input from the user can be received in any form, including acoustic, speech, tactile, or brain wave input. Exemplary output devices 716 include display devices such as an LCD (liquid crystal display) monitor, for displaying information to the user.

According to one aspect of the present disclosure, the above-described gaming systems can be implemented using a computer system 700 in response to processor 702 executing one or more sequences of one or more instructions contained in memory 704. Such instructions may be read into memory 704 from another machine-readable medium, such as data storage device 706. Execution of the sequences of instructions contained in the main memory 704 causes processor 702 to perform the process steps described herein. One or more processors in a multi-processing arrangement may also be employed to execute the sequences of instructions contained in memory 704. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., such as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. The communication network can include, for example, any one or more of a LAN, a WAN, the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computer system 700 can include clients and servers. A client and server are generally remote from each other and typically interact through a communication network. The relationship of client and server arises by virtue of computer programs running on the respective computers and having a client-server relationship to each other. Computer system 700 can be, for example, and without limitation, a desktop computer, laptop computer, or tablet computer. Computer system 700 can also be embedded in another device, for example, and without limitation, a mobile telephone, a PDA, a mobile audio player, a Global Positioning System (GPS) receiver, a video game console, and/or a television set top box.

The term “machine-readable storage medium” or “computer-readable medium” as used herein refers to any medium or media that participates in providing instructions to processor 702 for execution. Such a medium may take many forms, including, but not limited to, non-volatile media, volatile media, and transmission media. Non-volatile media include, for example, optical or magnetic disks, such as data storage device 706. Volatile media include dynamic memory, such as memory 704. Transmission media include coaxial cables, copper wire, and fiber optics, including the wires that comprise bus 708. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

As the user computing system 700 reads data and provides to the user, information may be read from the data and stored in a memory device, such as the memory 704. Additionally, data from the memory 704 servers accessed via a network the bus 708, or the data storage 706 may be read and loaded into the memory 704. Although data is described as being found in the memory 704, it will be understood that data does not have to be stored in the memory 704 and may be stored in other memory accessible to the processor 702 or distributed among several media, such as the data storage 706.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

To the extent that the terms “include,” “have,” or the like is used in the description or the claims, such term is intended to be inclusive in a manner similar to the term “comprise” as “comprise” is interpreted when employed as a transitional word in a claim. The word “exemplary” is used herein to mean “serving as an example, instance, or illustration.” Any embodiment described herein as “exemplary” is not necessarily to be construed as preferred or advantageous over other embodiments.

A reference to an element in the singular is not intended to mean “one and only one” unless specifically stated, but rather “one or more.” All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products. Other variations are within the scope of the following claims.

1. A method for generating contextually relevant text from image descriptions and user intent, comprising:
receiving an image and a user-defined intent for text output, the user-defined intent including at least a description of an intended use, a selected tone, and a selected content type for the text output;
generating a system message including at least a first text argument based on the user-defined intent for the text output;
analyzing the received image to generate a contextual description of the image;
modifying, in response to a selection for an image influence feature, the system message by prepending a second text argument including the contextual description of the image to the first text argument, wherein the image influence feature enables consideration of the image;
generating a query based on the system message; and
generating the text output based on the query, wherein the text output is formatted and structured according to a set of guidelines corresponding to the selected content type, and contents of the text output align with a semantic, stylistic, and thematic characteristics of the image.

2. The method of claim 1, further comprising generating a notification on a user device inviting the user to input the user-defined intent for the text output immediately after the user downloads the image.

3. The method of claim 1, wherein receiving the selection for the image influence feature further comprises providing a toggle option within a text generator interface that allows the user to activate or deactivate the image influence feature, wherein activating the image influence feature enables consideration of the contextual description of the image in the text output generation and deactivating the image influence feature disables consideration of the contextual description of the image in the text output generation.

4. The method of claim 1, further comprising embedding the generated text output with metadata that includes the contextual description of the image and the user-defined intent to facilitate indexing and retrieval of the text output.

5. The method of claim 1, further comprising presenting a preview of the text output in a layout corresponding to the selected content type on a text generator interface for user confirmation before finalizing the text output.

6. The method of claim 1, further comprising filtering the user-defined intent through a safety and privacy guideline checker to detect and respond to potentially offensive terms before generating the text output.

7. The method of claim 1, wherein the analyzing of the received image includes:
extracting visual elements such as colors, objects, and activities to enhance the contextual description; and
applying at least a portion of the visual elements to the text output.

8. The method of claim 1, wherein the generated text output is configured for dissemination across multiple social media platforms, each platform receiving a customized version of the text output.

9. The method of claim 1, wherein the user-defined intent includes a content type selection, the content type selection including options for various event invitations, and the generated text output is tailored to match a specific event theme and audience based on the content type selection.

10. The method of claim 1, wherein the selected tone is selected from tone options within a text generator interface, and the selected tone is dynamically adjusted in response to real-time sentiment analysis of the user-defined intent and the contextual description of the image.

11. A system configured for generating contextually relevant text from image descriptions and user intent, the system comprising:
one or more hardware processors configured by machine-readable instructions to: receive an image and a user-defined intent for text output, the user-defined intent including at least a description of an intended use, a selected tone, and a selected content type for the text output;
generate a system message including at least a first text argument based on the user-defined intent for the text output;
analyze the received image to generate a contextual description of the image;
modify, in response to a selection for an image influence feature, the system message by prepending a second text argument including the contextual description of the image to the first text argument, wherein the image influence feature enables consideration of the image;
generate a query based on the system message; and
generate the text output based on the query, wherein the text output is formatted and structured according to a set of guidelines corresponding to the selected content type, and contents of the text output align with a semantic, stylistic, and thematic characteristics of the image.

12. The system of claim 11, wherein the one or more hardware processors are further configured by machine-readable instructions to generate a notification on a user device inviting the user to input the user-defined intent for the text output immediately after the user downloads the image.

13. The system of claim 11, wherein the one or more hardware processors are further configured by machine-readable instructions to provide a toggle option within a text generator interface that allows the user to activate or deactivate the image influence feature, wherein activating the image influence feature enables consideration of the contextual description of the image in the text output generation and deactivating the image influence feature disables consideration of the contextual description of the image in the text output generation.

14. The system of claim 11, wherein the one or more hardware processors are further configured by machine-readable instructions to embed the generated text output with metadata that includes the contextual description of the image and the user-defined intent to facilitate indexing and retrieval of the text output.

15. The system of claim 11, wherein the one or more hardware processors are further configured by machine-readable instructions to present a preview of the text output in a layout corresponding to the selected content type on a text generator interface for user confirmation before finalizing the text output.

16. The system of claim 11, wherein the one or more hardware processors are further configured by machine-readable instructions to filter the user-defined intent through a safety and privacy guideline checker to detect and respond to potentially offensive terms before generating the text output.

17. The system of claim 11, wherein the analyzing of the received image includes:
extracting visual elements such as colors, objects, and activities to enhance the contextual description; and
applying at least a portion of the visual elements to the text output.

18. The system of claim 11, wherein the generated text output is configured for dissemination across multiple social media platforms, each platform receiving a customized version of the text output.

19. The system of claim 11, wherein the user-defined intent includes a content type selection, the content type selection including options for various event invitations, and the generated text output is tailored to match a specific event theme and audience based on the content type selection.

20. A non-transient computer-readable storage medium having instructions embodied thereon, the instructions being executable by one or more processors to perform a method for generating contextually relevant text from image descriptions and user intent, the method comprising:
receiving an image and a user-defined intent for text output, the user-defined intent including at least a description of an intended use, a selected tone, and a selected content type for the text output;
generating a system message including at least a first text argument based on the user-defined intent for the text output;
analyzing the received image to generate a contextual description of the image;
modifying, in response to a selection for an image influence feature, the system message by prepending a second text argument including the contextual description to the first text argument, wherein the image influence feature enables consideration of the image;
generating a query based on the system message; and
generating the text output based on the query, wherein the text output is formatted and structured according to a set of guidelines corresponding to the selected content type, and contents of the text output align with a semantic, stylistic, and thematic characteristics of the image.
